(19) United States
(12) Patent Application Publication
(10) Pub. No.: US 2006/0059339 A1
(43) Pub. Date: Mar. 16, 2006

(54) Reproducing apparatus and recording/reproducing apparatus

(75) Inventors: Susumu Yoshida, Kawasaki (JP); Naozumi Sugimura, Yokohama (JP); Takuya Imaide, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/114,947

(22) Filed: Apr. 25, 2005

(30) Foreign Application Priority Data
Sep. 16, 2004 (JP) 2004-269110

(51) Int. Cl. H04L 9/00

(52) U.S. Cl. 713/166

(57) ABSTRACT

A reproducing apparatus includes a software executing block for executing software having a predetermined format and a setting block capable of setting an arbitrary security level, wherein the software is executed in association with the AV data; and also includes a control unit for controlling to change an authentication operation of whether the software executing block is permitted to execute the software, thereby, when software stored in a disc is executed, a disc ID is compared with a past reproduction history, and only if both are not coincident, the authentication operation is executed.

### INCORPORATION BY REFERENCE

The present application claims priority from Japanese application JP2004-269110 filed on Sep. 16, 2004, the content of which is hereby incorporated by reference into this application.

### BACKGROUND OF THE INVENTION

The present invention relates to a reproducing apparatus and a recording/reproducing apparatus for recording/reproducing information to and from a recording medium.

As related background art, there has been JP-A-8-147159 that describes a virus check ID indicating whether a virus check has already been executed by a virus program for a purpose of preventing beforehand the virus program from invading a hard disc of a system. If there is the virus check ID, an access is permitted, whereas if the virus check ID does not exist, the disc is checked whether a virus program exists. If a virus program is not detected or if it is judged that the disc was infected by the virus program and the virus program was removed, a virus check ID is registered in the disc to permit access to files.

### SUMMARY OF THE INVENTION

In a multi-function AV apparatus, each function typically Graphical User Interface (GUI) is possibly realized in general software execution environments typically JAVA. If these software execution environments are used, it is not necessary to develop software for each apparatus and it is advantageous in that software once developed can be executed by any apparatus.

AV apparatuses having general software execution environments have an increased danger of infection by a software virus (hereinafter simply called a virus) via a network or a recording medium.

As compared to the field of PCs (Personal Computers) described in JP-A-8-147159, home AV apparatuses are required to provide each function which is easy to use. Namely, in realizing each function, even if general software is executed internally, a user is not requested to recognize each operation, and an I/F should not be used, which is hard to be understood the operation of recognizing the I/F.

In a reproducing apparatus and a recording/reproducing apparatus of the present invention, there is a possibility that a virus invades the apparatus not only via a network but also via a privately created recording medium or the like and it is necessary to consider a method capable of effectively checking a virus.

From the essential nature of an AV apparatus, reproduction and execution of data are performed, which data is trustworthy such as without virus infection. It is not preferable to always check a virus and consume time in a normal operation. A system is required to be considered, which system can select a security level indicating how a virus is checked and is provided with a user I/F easy to understand and specific to AV apparatuses.

The present invention has been made in consideration of these circumstances, and it is an object of the present invention to provide a reproducing apparatus and a recording/reproducing apparatus capable of efficiently checking a virus when a general software is executed and allowing a user to positively adjust a security level.

In order to achieve this object of the present invention, an I/F is prepared for allowing a user to set a security level as desired with simple operations. When software is executed, an authentication operation of whether the software execution is permitted or not is changed in accordance with a set security level.

According to the present invention, there are provided a reproducing apparatus and a recording/reproducing apparatus with improved operability.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart illustrating an operation of software execution in a recording/reproducing apparatus of the present invention.

FIG. 2 is a diagram showing an example of a security level setting screen.

FIG. 3 is a block diagram of the recording/reproducing apparatus.

FIG. 4 is a flow chart illustrating a reproduction operation at a security level 1.

FIG. 5 is a diagram showing an example of a content menu contained in a disc.

FIG. 6 is a diagram showing an example of a simple content menu display screen.

FIG. 7 is a flow chart illustrating a reproduction operation at a security level 2.

FIG. 8 is a diagram showing an example of an execution inhibition message display screen.

FIG. 9 is a flow chart illustrating a reproduction operation at a security level 3.

FIG. 10 is a diagram showing an example of a connection confirmation message display screen for a predetermined site.

FIG. 11 is a diagram showing an example of a confirmation screen at the predetermined site.

FIG. 12 is a diagram showing an example of a check result display screen at the predetermined site.

FIG. 13 is a schematic diagram showing the structures of the recording/reproducing apparatus and the predetermined site.

FIG. 14 is a diagram showing a check processing unit at the predetermined site.

FIG. 15 is a diagram showing a recording/reproducing apparatus according to a second embodiment of the present invention.

### DESCRIPTION OF THE EMBODIMENTS

The contents of a recording medium to be reproduced by a home reproducing apparatus or recording/reproducing apparatus may include mainly AV data, its additional information or its related software. This software is executed in connection with the AV data.

A main object of a user is to view AV data. As the software is executed, retrieval of the AV data becomes easy, and related additional information (e.g., who appears, where photographed and the like) can be reproduced synchronously with the AV data.

AV data may be one of video data and audio data, or both video data and audio data.

The AV data corresponds to main data of the movie like DVD of videos for sale. Reproduction of AV data itself has a small possibility of damaging the apparatus directly. However, the software is executed in general software execution environments, and if the software contains a virus or the like, the apparatus may have large damages when the software is executed.

In the following embodiments, with reference to the accompanying drawings, description will be made specifically on how authentication is executed to judge whether software is executed or not.

### First Embodiment

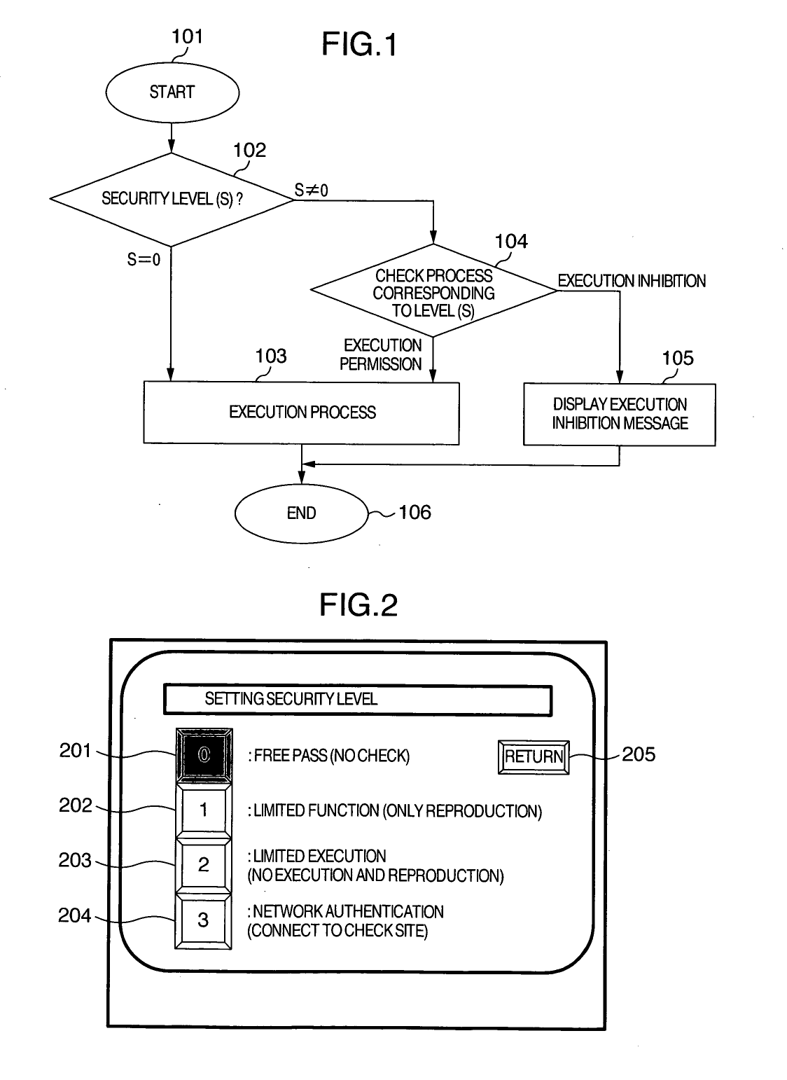

FIG. 1 is a flow chart illustrating an example of an operation of executing general software recorded in a recording medium of a recording/reproducing apparatus of the present invention. In FIG. 1, S101 is a start step, S102 is a security level judgement step, S103 is an execution process step, S104 is a check step, S105 is an execution inhibition message display step, and S106 is an end step.

As the operation starts (S101) executing desired software, a security level L set to the recording/reproducing apparatus is confirmed (S102). If L=0 (lowest level), the software is executed (S103). If L is not 0 (other than the lowest level), a check process such as a virus check corresponding to the set L is executed (S104). If the check process judges that execution is permitted, the software is executed (S103). In the check process judges that execution is inhibited, an execution inhibition message is displayed (S105) to a user (S105) to thereafter terminate the process (S106).

The security level L can be selected by a user. For example, a user can positively raise the security level of the recording/reproducing apparatus if virus infection of general software is alarmed publicly. Some user may feel cumbersome to check each time general software is executed and may always desire a priority of operation smoothness by bearing individual responsibility. In this case, setting of L=0 (lowest level) can be made.

For setting the security level, a security level setting screen such as shown in FIG. 2 is prepared specifically, as one of system setting items of the recording/reproducing apparatus. In selecting the security level, a user uses the recording/reproducing apparatus itself, or a cursor key and an execution key provided in a remote controller. The set contents are stored in a system memory of the recording/reproducing apparatus, along with the other system setting items. In the case of the embodiment, level settings in four stages will be explained as possibilities.

If a user selects a button 201 to set L=0, as described earlier any software is executed without the check process such as virus check. If the user selects a button 202 to set L=1, any software is executed by limiting its function. In the general software execution environments typically JAVA and the like, a plurality of command groups are prepared and a proper combination of commands is executed according to the read software. Since it can be considered that a virus is attached to a particular command, only necessary and minimum commands are executed. However, even necessary and minimum commands are executed, executing the software in the general software execution environment may have by itself a risk. All commands may also be limited. The details of an operation example will be later given.

If the user selects a button 203 to set L=2, execution of any software is limited. Namely, in accordance with some judgement criterion, execution and reproduction of all contents contained in the disc are not performed. This is because some contents require to execute software in the recording medium when AV data is reproduced. One example of executing software in association with the AV data is execution of software when AV data is reproduced normally. However, if AV data can be reproduced without executing the software in the recording medium, the AV data may be reproduced without executing the software even at the setting of L=2.

If the user selects a button 204 to set L=3, when any software is executed, the check process is performed at a predetermined site on an external network. The predetermined site is an officially managed facility such as a specification organization of recording media of recording/reproducing apparatuses. If the authentication at this site is not performed, execution and reproduction are not performed.

A button 205 is prepared for returning to an initial system setting screen. This button is not essential if the same function is realized by a cancel key of a remote controller or the like.

In FIG. 2, although the recording/reproducing apparatus has a GUI screen including setting buttons for system setting, the invention is not limited only to the GUI screen but a user I/F capable of setting a desired security level may also be used.

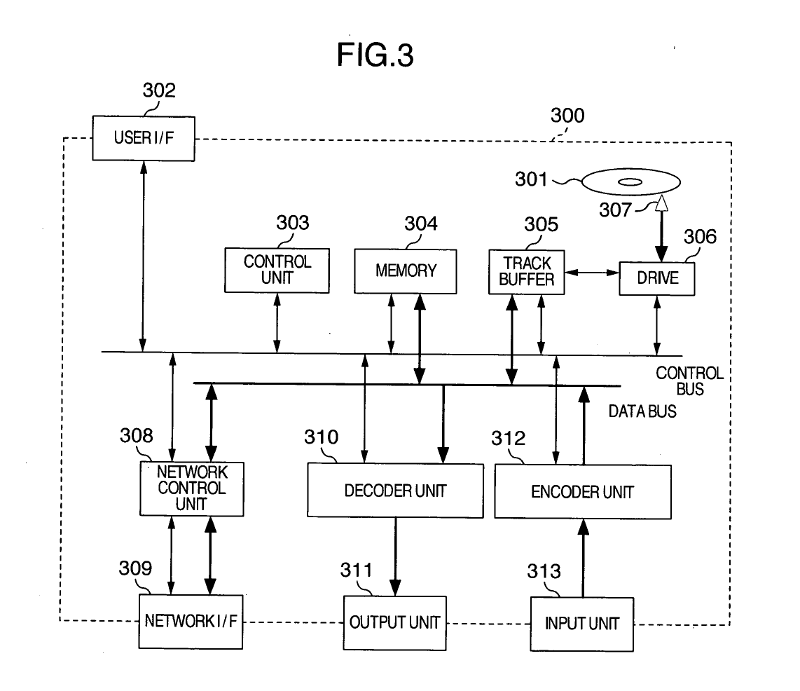

With reference to FIG. 3, description will be made on the details of the recording/reproducing apparatus according to the embodiment of the present invention. FIG. 3 is a block diagram of the recording/reproducing apparatus of the present invention using an optical disc as the recording medium. Reference numeral 300 represents a recording/reproducing apparatus, reference numeral 301 represents an optical disc, reference numeral 302 represents a user I/F, reference numeral 303 represents a control unit, reference numeral 304 represents a memory, reference numeral 305 represents a track buffer, reference numeral 306 represents a drive, reference numeral 307 represents a pickup, reference numeral 308 represents a network control unit, reference numeral 309 represents a network I/F, reference numeral 310 represents a decoder unit, reference numeral 311 represents an output unit, reference numeral 312 represents an encoder unit, and reference numeral 313 represents an input unit.

First, a reproduction operation will be described. When a reproduction operation is to be started, a user inserts a desired optical disc 301 into the recording/reproducing apparatus 300 and makes a reproduction instruction by using a remote controller or a key on the recording/reproducing apparatus. The reproduction instruction entered by the user via the user I/F 302 is analyzed by the control unit 303 which in turn starts the reproduction of the optical disc 301. However, depending upon the data structure of the optical disc 301, initial activation software is executed without the user instruction.

Recorded in the optical disc 301 are not only AV files but also a play list file indicating a file reproduction order, a program file for executing a predetermined procedural process corresponding to the above-described general software execution environment. First, file management information is read in order to discriminate files recorded in the optical disc 301. More specifically, the control unit 303 instructs the drive 306 to read anchor information on a predetermined sector and makes the optical pickup 307 read data written in the predetermined sector. In accordance with this information, a record position of the file management information is obtained to thereby read the file management information. In recording the file management information, a file system typically Universal Disc Format (UDF) for example may be used. By using the file system, information recorded on the disc can be processed as a file, and the file to be read can be designated by a file identifier (file name).

For starting the reproduction, a file designated by the management information file is read to read initial startup software. More specifically, the control unit 303 operates to read the designated file from the optical disc 301. At this stage, since software information is added to the file, the process is performed in accordance with this software. Namely, if the first read file is the file corresponding to the initial startup software, the control unit 303 uses the read file as software to be executed in the general software execution environment.

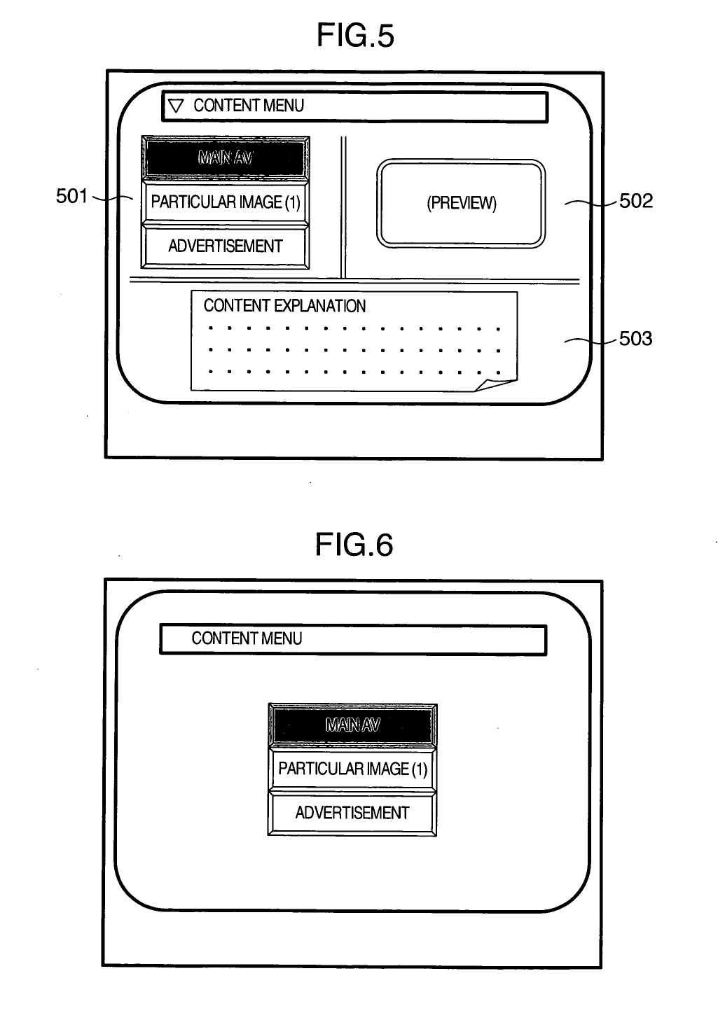

At the stage immediately before execution, the security level L set to the system is checked. If L=0, the software read from the optical disc 301 is developed in a storage area of the control unit 303 to sequentially analyze and execute it. For example, if the initial startup software corresponds to a browser for displaying a disc content menu, a content menu screen such as shown in FIG. 5 is displayed by executing the software.

In FIG. 5, reference numeral 501 represents an index display area, reference numeral 502 represents a preview screen display area, and reference numeral 503 represents a content explanation display area. A user moves a cursor to a button indicating a desired content in the index display area 501. A preview screen corresponding to the selected content, i.e., a moving image of an actual content, is displayed in the preview display area 502. At the same time, the content explanation corresponding to the selected content, is displayed in the content explanation display area 503. As the user selects the desired content button in the index display area, a more detailed chapter menu screen may be displayed, the reproduction operation is executed at once, or other various operations may be executed. In this manner, the user can enjoy the reproduced scenes intended by a creator of the content recorded in the optical disc, by executing the software in the general software execution environment.

Description will be made on a content reproduction operation of reproducing an actual AV file. As a particular content is eventually determined in the screen shown in FIG. 5, the control unit 303 starts reproducing predetermined stream data recorded in the optical disc 301. In response to an instruction from the control unit 303, the drive 306 controls the pickup 307 to read the stream data from the optical disc 301 at an arbitrary data position and store it once in the track buffer 305. The stream data is read from the track buffer 305 by absorbing a difference between a transfer rate of the driver 306 and a coding rate of the stream data, and separated and decoded into video data and audio data by the decoder unit 310, and output from the output unit 311 in a proper signal format.

The above-described content menu screen along with other screens to be presented to a user other than a reproduction screen are also output from the output unit 311 via the decoder unit 310 and the memory 304 and control unit 303, or the network control unit 308.

Next, a recording operation will be described briefly. A recording operation is performed in a reversed order of the reproduction operation. Data input from the input unit 313 is A/D converted if necessary, and the encoder unit 312 encodes and multiplexes video data and audio data to generate stream data which is once stored in the track buffer 305. The stream data is read from the track buffer 305 by absorbing a difference between a transfer rate of the drive 306 and a coding rate of the stream data, and recorded in the optical disc 301 at a predetermined address via the pickup 307.

The input unit 313 may include a reception unit for receiving broadcast data. If the reception content is digital data already encoded and multiplexed, the operation at the encoder unit 312 is omitted.

Next, a network operation will be described. If a predetermined address on an external network is to be accessed, the control unit 303 passes necessary information to the network control unit 308 which in turn analyzes it and accesses the predetermined address on the external network via the network I/F 309. Data may be transmitted via the network I/F 309 or may be acquired from the external and stored in the memory 304 to be used for a predetermined operation.

Next, description will be made on a more specific example of the execution operation of software if the above-described security level L is not 0. In the following description, it is assumed that a disc recording particular AV data also records a content menu browser as the initial startup software.

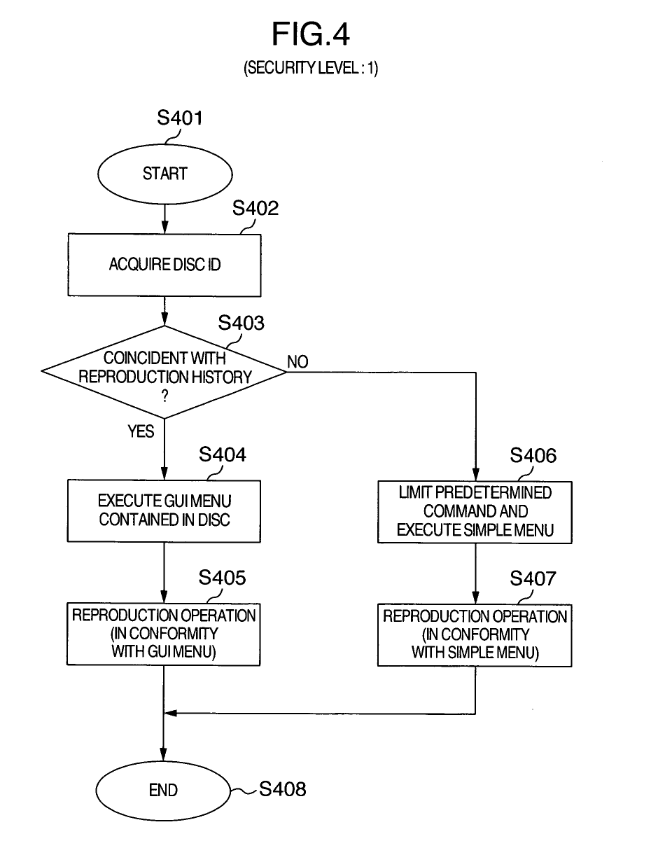

FIG. 4 is a flow chart illustrating the reproduction operation when the security level L is set to 1. S401 represents a start step, S402 is a disc ID acquisition step, S403 is a coincidence judgement step with a reproduction history, S404 is a GUI menu execution step, Step S405 is a reproduction operation step (in conformity with a GUI menu), S406 is a simple menu execution step, S407 is a reproduction operation step (in conformity with a simple menu), and S408 is an end step.

As the operation starts (S401), since the security level L is 1, a disc ID of the optical disc 301 shown in FIG. 3 is acquired (S402). More specifically, the control unit 301 sends an instruction to the drive 306 to read a disc identification number called Burst Cutting Area (BCA). The drive 306 reads BCA information recorded in the optical disc 301 and returns it to the control unit 301. BCA records numerical values standing for a creator, a title, a series name, a serial number and the like of the content recorded in the disc, which are used as the disc ID.

The acquired disc ID is compared with a past reproduction history stored in the memory of the recording/reproducing apparatus (S403). If the disc was reproduced in the past, it means that there is no risk of virus infection or the like. Therefore, similar to the case of L=0, the initial startup software is executed and the content menu shown in FIG. 5 is displayed (S404). Thereafter, a usual reproduction operation is executed in accordance with a user instruction (S405) to thereafter terminate the operation (S408).

If the coincidence judgement step S403 with the reproduction history indicates that the disc ID does not coincide with the past reproduction history, i.e., if the disc is reproduced for the first time in the recording/reproducing apparatus, the initial startup software is executed limitatively. Namely, since viewing the recorded AV data as the content of the optical disc is a minimum object of the user, only the menu display command is validated and other commands are not made executable. Therefore, for example, as shown in FIG. 6, a menu screen by simple GUI is displayed and only the index display area 501 shown in FIG. 5 is displayed. Since the user can select a desired content, an AV data reproduction operation is possible (S407).

In this embodiment, although the disc ID is compared with the past reproduction history at the coincidence judgement step S403 with the reproduction history, this judgement process may not be executed but the software may be executed by always limiting the command at L=1. This is particularly effective if a disc itself is created privately and the identification of a file unit is not clear. Furthermore, in this embodiment, although the execution command for the software is limited and a simple GUI menu is displayed, if the recording/reproducing apparatus itself has a processing function corresponding to a simple browser, a menu may be displayed by this browser function by limiting all commands at L=1.

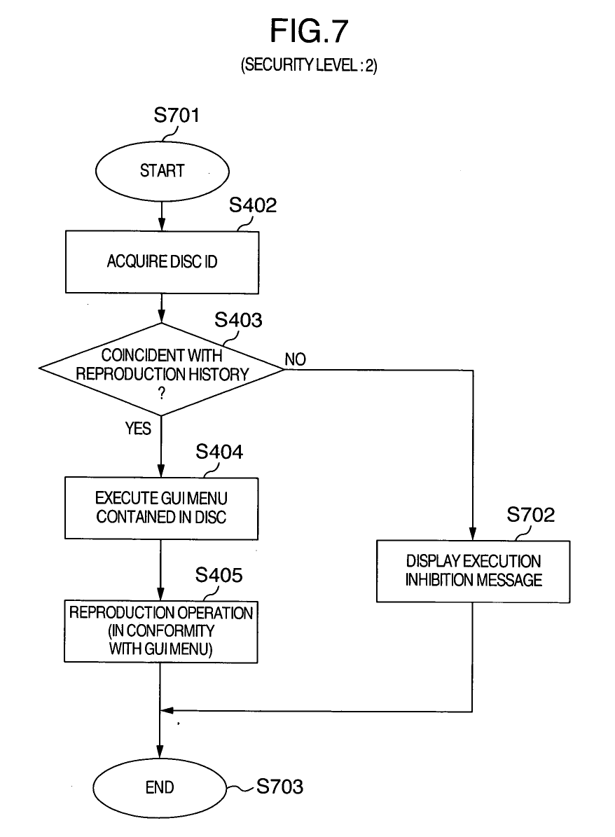

Next, the operation at the security level L is 2 will be described. FIG. 7 is a flow chart illustrating the reproduction operation at L=2. Steps corresponding to those shown in FIG. 4 are represented by identical symbols and the detailed description thereof will be omitted. S701 is a start step, S702 is an execution inhibition message display step and S703 is an end step.

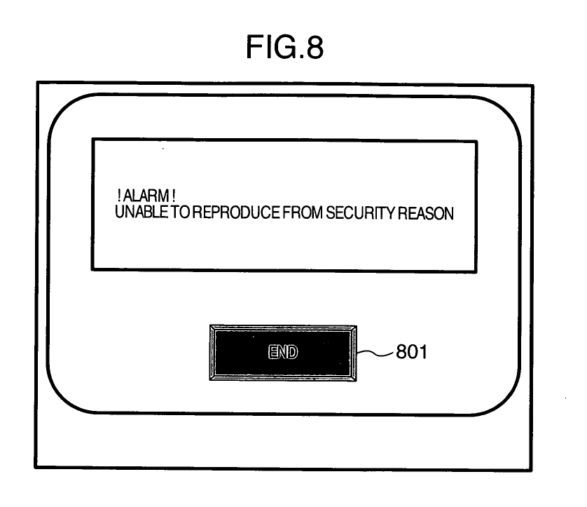

Similar to L=1, as the operation starts (S701), a disc ID is acquired (S402). The acquired disc ID is compared with a past reproduction history to judge if there is coincidence (S403). As different from L=1, if the disc ID does not coincide with the past reproduction history, all operations are inhibited and an execution inhibition message such as shown in FIG. 8 is displayed (S702). A user is allowed only to select an end button 801, and selects this button to terminate the operation (S703). If the content of the disc cannot be known and is not desired to access, this operation of the embodiment is effective. Namely, not only the software in the disc but also the AV data can be limited not to be reproduced.

Also in this embodiment, similar to the case of L=1, the coincidence judgement step S403 may not compare the disc ID with the past reproduction history, but all operations are always inhibited at L=2 and the execution inhibition message may be displayed.

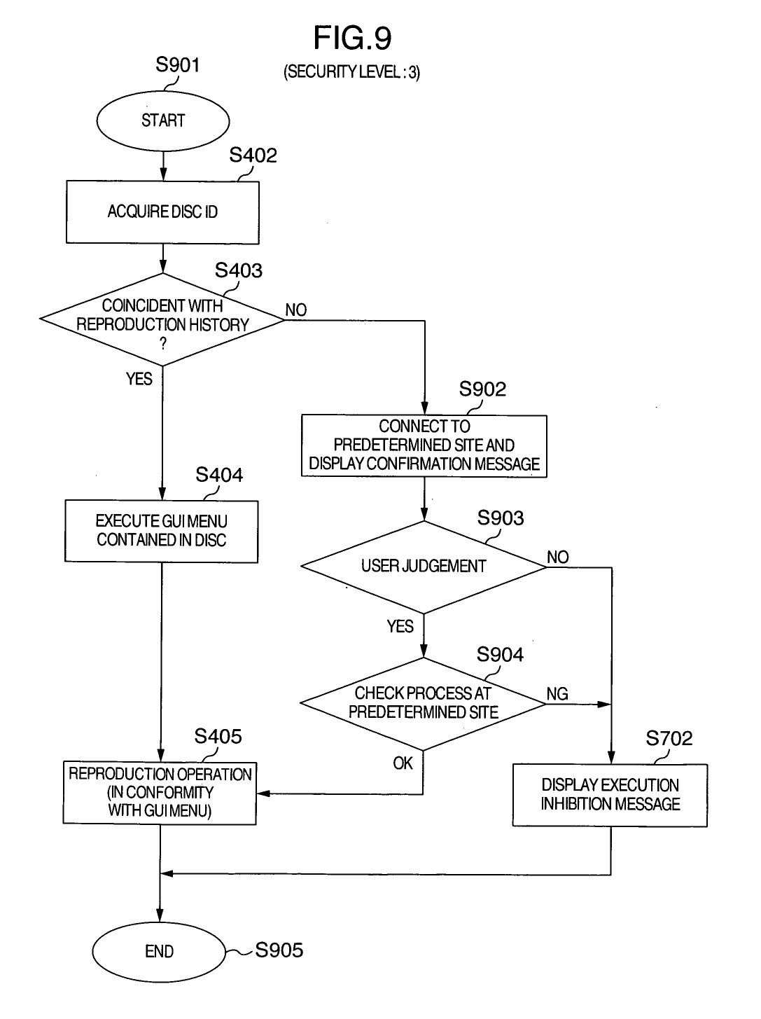

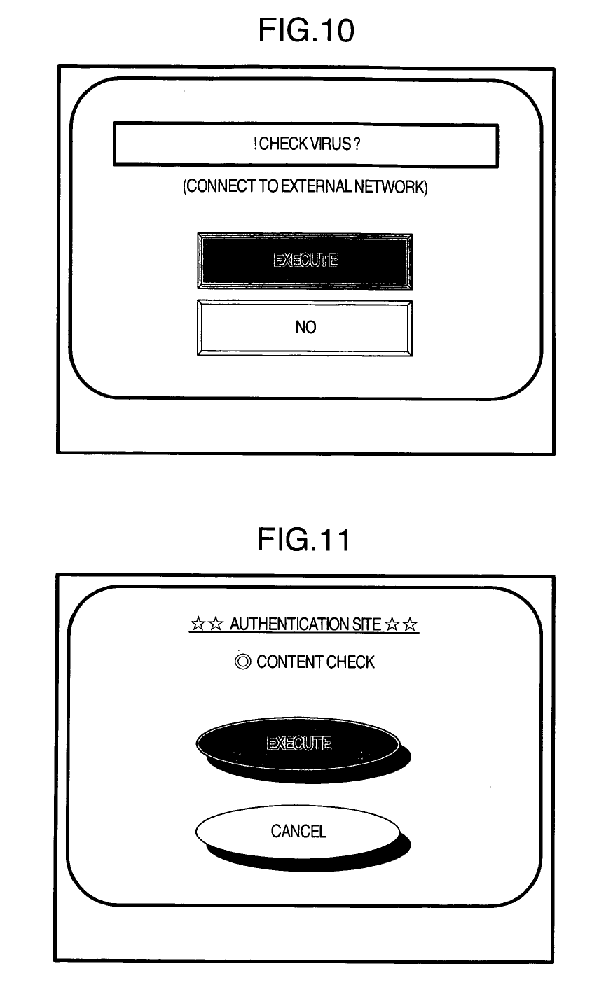

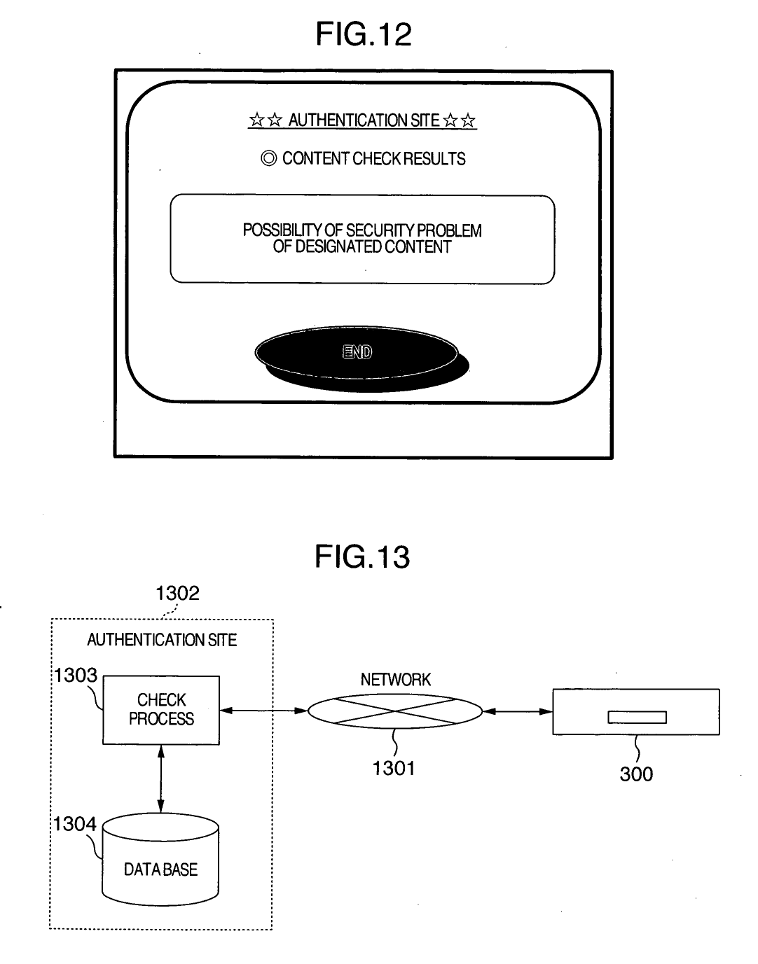

Next, the operation at the security level L=3 will be described. FIG. 9 is a flow chart illustrating the reproduction operation at L=3. Steps corresponding to those shown in FIGS. 4 and 7 are represented by identical symbols and the detailed description thereof is be omitted. S901 is a start step, S902 is a connection confirmation message display step relative to a predetermined site, Step S903 is a user judgement step, S904 is a check process step at the predetermined site and S905 is an end step. Similar to L=1 or L=2, as the operation starts (S901), a disc ID is acquired (S402). The acquired disc ID is compared with a past reproduction history to judge if there is coincidence (S403). If the disc ID does not coincide with the past reproduction history, a confirmation message screen is displayed to confirm whether an external network is connected (S902). For example, a screen such as shown in FIG. 10 is displayed to make it easy for the user to understand. If a user judgement (S903) indicates that a connection to the external network is not to be established, an execution inhibition message similar to that shown in FIG. 8 is displayed (S702) to thereafter terminate the process (S905). If a user judgement (S904) indicates that a connection to the external network is to be established, the above-described authorized authentication site is accessed whereat a check process is executed (S904). When the authentication site is accessed, an initial screen such as shown in FIG. 11 is displayed. As the user instructs to execute the content check, the content check is performed. If the check result is OK, the recording/reproducing apparatus executes the initial startup software, displays a GUI menu and executes the reproduction operation in conformity with the GUI menu (S405). If the check result is NG, a check result screen such as shown in FIG. 12 prepared on the side of the authentication site may be displayed, or similar to the operation described above, an execution inhibition message screen prepared on the side of the recording/reproducing apparatus such as shown in FIG. 8 may be displayed (S702) to thereafter terminate the process (S905).

When the predetermined site is to be accessed, the address thereof on the network is designated by using identification information, called Unified Resource Locator (URL). It is assumed that URL is registered beforehand in the recording/reproducing apparatus, or it may be rewritten externally. In this embodiment, when the predetermined site is connected, it is assumed that an execution confirmation screen of a content check prepared at the predetermined site is displayed. For displaying this confirmation screen, a browser may become necessary in some cases. Therefore, while the predetermined site performs the check process (S904), a GUI screen of the recording/reproducing apparatus may be displayed instead of displaying the screen prepared on the side of the predetermined site.

Similar to the operation described above, and similar to the case of L=1, the coincidence judgement step S403 may not compare the disc ID with the past reproduction history, but a user may always be urged to perform the check at the predetermined site at L=3.

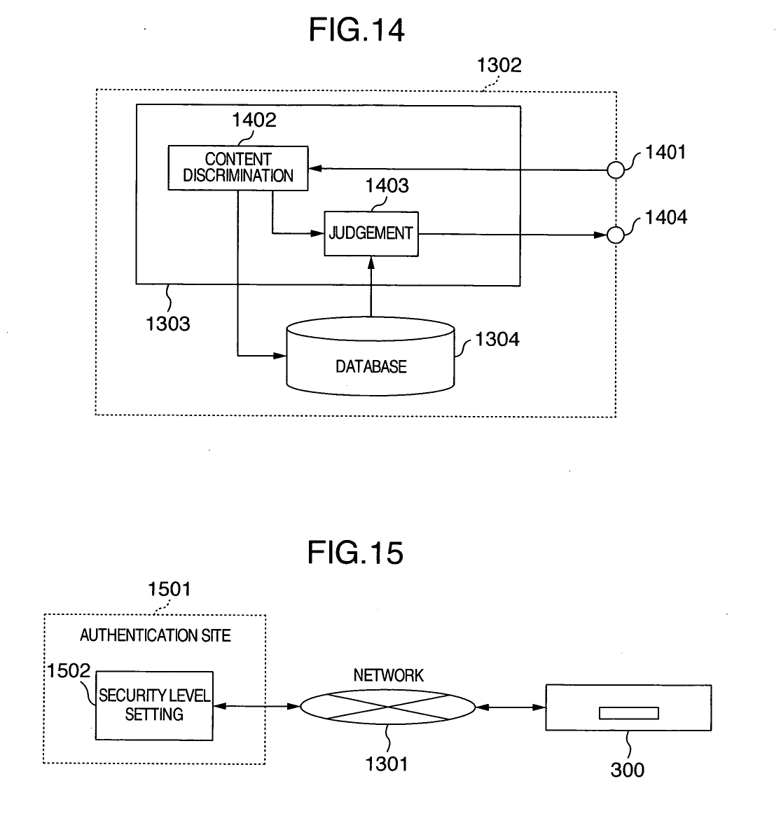

With reference to FIGS. 13 and 14, more detailed description will be made on the content check operation at the predetermined site. FIG. 13 is a schematic diagram showing the structures of the recording/reproducing apparatus and the predetermined site on the network. Reference numeral 300 represents the recording/reproducing apparatus shown in FIG. 3, reference numeral 1301 represents a network, reference numeral 1302 represents an authentication site, reference numeral 1303 represents a check processing unit, and reference numeral 1304 represents a database. FIG. 14 is a diagram showing the details of the check processing unit 1303 of the authentication site 1302, reference numeral 1401 represents an input unit, reference numeral 1402 represents a content discrimination unit, reference numeral 1403 represents a judgement unit and reference numeral 1404 represents an output unit.

If a user judges at the recording/reproducing apparatus 300 that the content check should be executed on the network, the check processing unit 1303 of the authentication site 1302 acquires necessary information on the content and checks the content by using predetermined data in the database 1304. More specifically, disc ID information acquired at the disc ID acquisition step S402 shown in FIG. 9 is input from the input unit 1401 to the content discrimination unit 1402. The content discrimination unit extracts information necessary for judging virus infection and the like from the input information, and notifies the extracted information to the database 1304 and to the judgement unit 1403. The judgement unit 1403 judges, from the information supplied from the content discrimination unit 1402 and the information supplied from the database 1304, whether the content is safe, and outputs a judgement result from the output unit 1404.

In the above-described embodiment, although the disc ID is acquired at the first judgement process, the embodiment is not limited thereto. For example, if identification information of a file unit can be acquired, the file unit may be used as a judgement criterion. Also in the above-described embodiment, although the initial startup software recorded in a disc is always executed, it is obvious that the recording/reproducing apparatus may store software downloaded from an external network in its internal memory and execute the software in the general software execution environment to check a content in accordance with the security level as described earlier. In this case, the disc ID is not necessary to be checked, but the check at each security level is always performed. In the above-described embodiment, although the number of security levels is four, the number of security levels is not limited to a particular number.

With the above-described embodiment, it becomes possible for a user to positively select the security level by using an intuitive I/F, and it becomes possible to inhibit the execution of a virus which might damage the apparatus.

### Second Embodiment

FIG. 15 is a schematic diagram showing the structures of a recording/reproducing apparatus and a predetermined site on a network, according to the second embodiment of the present invention. Reference numeral 300 represents a recording/reproducing apparatus, reference numeral 1301 represents a network, reference numeral 1501 represents an authentication site, and reference numeral 1502 represents a security level setting unit. The authentication site 1501 may be the same as the authentication unit 1302 shown in FIG. 13 or may be different from the authentication unit 1302.

A different point of the second embodiment from the first embodiment resides in that setting the security level of the recording/reproducing apparatus 300 can be set externally via the network. If the authentication site 1501 judges socially that the security level should be changed, the security level setting unit 1502 changes the security level of the recording/reproducing apparatus 300 on the user side via the network. The content check operation at each security level is the same as that of the first embodiment, and the description thereof is omitted.

Since a user is not necessary to acquire external update information and change the security level, the security can be improved. However, since some users are not necessary to forcibly change the security level, it is possible to use the positive security level changing device of the first embodiment in addition to the forcible security level change.

With the above-described embodiment, it becomes possible for a user to select the security level and execute a software authentication operation by a desired method, and it becomes possible to inhibit the execution of a virus which might damage the apparatus.

If an operation which has apparently no danger is to be performed, an unnecessary process will not be executed by adjusting the security level so that easy-to-use of the apparatus will not be degraded.

Security of the reproducing apparatus and recording/reproducing apparatus can be improved without involvement of user recognition, by allowing the security level to be changed externally.

It should be further understood by those skilled in the art that although the foregoing description has been made on embodiments of the invention, the invention is not limited thereto and various changes and modifications may be made without departing from the spirit of the invention and the scope of the appended claims.

1. A reproducing apparatus for reproducing AV data recorded in a recording medium, comprising:
software executing means for executing software having a predetermined format; and
setting means capable of setting an arbitrary security level,
wherein:
said software is executed in association with said AV data; and
the reproducing apparatus includes a control unit for controlling to change an authentication operation of whether said software executing means is permitted to execute said software.

2. The reproducing apparatus according to claim 1, wherein when said setting means sets a lowest security level, said control unit controls to make said software executing means execute said software without performing the authentication operation.

3. The reproducing apparatus according to claim 1, wherein:
said software executing means has an environment of executing a plurality of commands; and
when said setting means sets a predetermined security level, said control unit controls to make said software executing means execute said software, by invalidating only a predetermined command among said plurality of commands.

4. The reproducing apparatus according to claim 1, wherein when said setting means sets a predetermined security level, said control unit controls to make said software executing means not execute said software.

5. The reproducing apparatus according to claim 1, further comprising:
connection means for connecting an external network,
wherein when said setting means sets a predetermined security level, said control unit controls to make said software executing means execute said software, by making said connection means connect a predetermined site on the external network and making said predetermined site perform the authentication operation.

6. The reproducing apparatus according to claim 1, wherein said software is read from said recording medium.

7. The reproducing apparatus according to claim 6, further comprising: recording medium identification information acquiring means; non-volatile memory means; and judgement means, wherein:
said memory means stores a history of identification information of the recording medium reproduced in a past; and
said control unit controls to make said software executing means execute said software, by making said judgement means compare identification information acquired by said recording medium identification information acquiring means with the history of the identification information stored in said memory means and if it is judged that said software is contained in said recording medium reproduced in the past.

8. The reproducing apparatus according to claim 1, further comprising memory means, wherein said software is read from said memory means.

9. The reproducing apparatus according to claim 1, wherein setting the security level by said setting means is performed via an external network.

10. A recording/reproducing apparatus for recording information in a recording medium, the recording/reproducing means has a function of the reproducing apparatus recited in claim 1.

11. A reproducing method of reproducing AV data recorded in a recording medium, comprising:
a level selecting step of selecting an arbitrary security level;
an authentication operation changing step of changing an authentication operation of software to be executed in association with said AV data, in accordance with the security level selected by said level selecting step; and
a software executing step of executing the software permitted by the authentication operation changed by said authentication operation changing step.

12. The reproducing method according to claim 11, wherein when said level selecting means selects a lowest security level, said authentication operation changing means changes a procedure so as not to perform the authentication operation when said software is executed.

13. The reproducing method according to claim 11, wherein:
said software has a plurality of commands; and
when said level selecting step sets a predetermined security level, said authentication operation changing step changes so as to execute only a predetermined command among said plurality of commands.

14. The reproducing method according to claim 11, wherein when said level selecting step sets a predetermined security level, said authentication operation changing step changes so as not to execute said software.

15. The reproducing method according to claim 11, wherein said software is read from said recording medium.

16. A reproducing apparatus for reproducing information data recorded in a recording medium, comprising:
software executing means for executing software having a predetermined format; and
setting means capable of setting an arbitrary security level,
wherein:
said software executing means executes said software in association with said information data; and
the reproducing apparatus includes a control unit for controlling to change an authentication operation of whether said software executing means is permitted to execute said software.
